(19) United States
(12) Patent Application Publication
(10) Pub. No.: US 2016/0160713 A1
(43) Pub. Date: Jun. 9, 2016

(54) LUBRICATION SYSTEM FOR POWER TRANSFER UNIT HAVING EXTERNALLY-MOUNTED ELECTRIC OIL PUMP

(71) Applicant: Magna Powertrain of America, Inc., Troy, MI (US)

(72) Inventor: Mitchell D. Reedy, Rochester Hills, MI (US)

(21) Appl. No.: 14/560,196

(22) Filed: Dec. 4, 2014

(51) Int. Cl. F01M 1/02; F16D 13/74; F16H 57/04; F16N 7/40

(52) U.S. Cl. CPC F01M 1/02; F16N 7/40; F16D 13/74; F16H 57/0434

(57) ABSTRACT

The present disclosure relates to an on demand lubrication system for use in torque transfer mechanisms of the type associated with power transfer systems in motor vehicles. The on-demand lubrication system includes an externally-mounted electric motor/pump assembly adapted to draw lubricant from a sump located within the dosed housing of the torque transfer mechanism and supply pressurized lubricant to one or more remote locations within the housing. The output of the electric motor/pump assembly is fluidically connected to a reservoir assembly via an elongated conduit.

### FIELD OF THE INVENTION

The present disclosure relates generally to power transfer systems for motor vehicles and, more particularly, to on-demand lubrication of torque transfer mechanisms associated with such power transfer systems.

### BACKGROUND OF THE INVENTION

This section provides background information related to the present disclosure which is not necessarily prior art.

Power transfer systems of the type used in motor vehicles such as, for example, four-wheel drive (4WD) transfer cases, all-wheel drive (AWD) power take-off units, axle drive modules, torque couplings and limited slip differential assemblies are commonly equipped with a torque transfer mechanism. Such torque transfer mechanisms are configured and operable to regulate the transfer of drive torque from a rotary input member to a rotary output member. Typically, the torque transfer mechanism includes a multi-plate friction clutch operably disposed between the input and output members and a clutch actuator for engaging the friction clutch. The degree of clutch engagement, and therefore the amount of drive torque transferred, is a function of the clutch engagement force applied to the friction clutch via the clutch actuator.

The clutch actuator typically includes a drive mechanism and a clutch operator mechanism. The clutch operator mechanism is operable to convert the force or torque generated by the drive mechanism into the clutch engagement force which, in turn, is applied to the friction clutch. The drive mechanism can be passively actuated or, in the alternative, can include a power-operated device which is controlled in response to the control signals from an electronic control unit (ECU) associated with a traction control system. Variable control of the control signals is typically based on changes in road conditions and/or the current operating characteristics of the vehicle (i.e., vehicle speed, acceleration, brake status, steering angle, interaxle speed differences, etc.) as detected by various sensors associated with the traction control system. As such, highly precise control of the drive torque transferred in such adaptive or “on-demand” torque transfer mechanisms permits optimized torque distribution during all types of driving and road conditions.

One factor that impacts the precision or accuracy of the drive torque actually transferred across the friction clutch is the frictional interface between the interleaved clutch plates associated with the multi-plate clutch pack. When the clutch pack is partially engaged, the clutch plates slip relative to one another and generate heat. As is known, lubricating fluid may be routed to flow through the clutch pack to cool the clutch plates as well as the other clutch components in addition to lubricating bearings and other rotary components within the torque transfer mechanism. It is well documented that excessive heat generation can degrade the lubricating fluid and damage the clutch plates.

Additionally, and as mentioned above, the traction control system is configured to require the clutch actuator to respond to torque commands in a quick and highly precise manner. The ability to accurately meet these torque requests is dependent on the coefficient of friction of the clutch plates. However, it has been demonstrated that this coefficient can change quite rapidly under various loading and/or slip conditions. Specifically, the frictional coefficient tends to fade due to significant temperature increases in the clutch plates which results from insufficient heat removal. It has, however, also been demonstrated that improvements in the flow of lubricating fluid to the friction clutch can improve the stability of the friction coefficient. In particular, the flow rate across the clutch pack has a significant impact on the stability of the friction coefficient, especially during continuous plate slip conditions.

A number of different types of lubrication systems are used in current torque transfer mechanisms. One lubrication system employs a shaft-drive fluid pump gerotor pump) that functions to generate a pumping action for supplying lubricating fluid from an internal reservoir or sump to the friction clutch in response to rotation of a driven shaft. Such shaft-driven fluid pump lubrication systems are inefficient due to the continuous pumping operation and the large pumping capacity required to provide adequate lubricant flow rates at both low and high rotational speeds. An example of a transfer case equipped with a shaft-driven lubricant pump is disclosed in U.S. Pat. No. 7,178,652. Another type of lubrication system used in some torque transfer mechanisms, referred to as a “pump-less” system, relies on rotary components to pressurize and transmit the lubricating oil from the sump to the friction clutch. While such systems are capable of eliminating the need for a pump to provide the lubricant flow requirements, the flow rate and capacity is still directly proportional to the rotary speed of the pump-less components.

It is also known to provide a shaft-driven fluid pump with a pump clutch that is operable for selectively coupling and uncoupling a pump component to the shaft to provide a “disconnectable” pump assembly. Such an arrangement permits on-demand operation of the fluid pump, but its flow rate and capacity are still a function of the shaft speed. An example of a torque coupling equipped with a disconnectable lubrication pump is disclosed in U.S. Pat. No. 7,624,853. Finally, it is also known to mount an electric fluid pump within the sump of a transfer case. The submerged electric pump can provide on-demand pumping operation independent of shaft speed. Unfortunately, the integration of the fluid pump inside the torque transfer mechanism makes repair or replacement thereof an extremely difficult and expensive rebuild operation. An example of a submerged electric fluid pump for use in vehicular power transfer systems is disclosed in U.S. Pat. No. 7,174,998.

In view of the above, it is recognized that optimized lubrication and cooling of torque transfer mechanisms is highly desirable to provide enhanced torque control, improved coefficient stability and extended service life of the clutch components and the bearings. Thus, a need exists to develop improved lubrication/cooling systems for use in power transfer systems which overcome the shortcomings of conventional shaft-driven and submerged lubrication pumps.

### SUMMARY OF THE INVENTION

This section provides a general summary of the disclosure, and is not a comprehensive disclosure of its full scope or ail of its features.

It is an object of the present disclosure to provide an on-demand lubrication system for a torque transfer mechanism including a housing and an electric fluid pump mounted to an external surface of the housing.

It is another object of the present disclosure to provide the on-demand lubrication system for a transfer case such that the electric fluid pump is mounted to a front housing section of the transfer case housing.

It is yet another object of the present disclosure to provide the on-demand lubrication system with a shaft reservoir assembly and a supply tube fluidically interconnecting an outlet of the electric fluid to a reservoir chamber within the shaft reservoir assembly.

In a related object of the present disclosure, the reservoir chamber of the shaft reservoir assembly is in fluid communication with a lubrication flow passage formed in a shaft so as to provide lubricating fluid to bearings supporting rotary components on the shaft and components of a multi-plate friction clutch operably disposed on the shaft.

It is a further object of the present disclosure to configure the on-demand lubrication system for use in torque transfer mechanisms of the type used for transferring drive torque and/or limiting slip in vehicular driveline applications.

It is a still further object of the present disclosure to integrate the on-demand lubrication system into a torque transfer mechanism having a first rotary member, a second rotary member, a multi-plate friction clutch disposed between the first and second rotary members, a clutch operator for regulating engagement of the friction clutch, and a drive unit for controlling acuation of the clutch operator.

These and other objects, features and aspects of the present disclosure are provided by a torque transfer mechanism for use in a motor vehicle to transfer torque from a first rotary member. The torque transfer mechanism comprises: a housing defining an enclosed chamber and configured to rotatably support each of the first and second rotary members; a supply of liquid lubricant disposed within a sump portion of said enclosed chamber; an on-demand lubrication system including an electric motor/pump assembly, a reservoir assembly, and a conduit assembly, said electric motor/pump assembly being mounted to an external surface of said housing and disposed in a cavity defining an inlet port and an outlet port which both communicate with said enclosed chamber, said electric motor/pump assembly operable to draw lubricant from said sump portion into said inlet port and discharge pressurized lubricant from said outlet port, said conduit assembly providing a fluid pathway from said outlet port to an inlet aperture in said reservoir assembly, said reservoir assembly surrounding one of the first and second rotary members and defining an annular channel providing fluid communication between said inlet aperture and a control lubrication channel formed in the one of the first and second rotary members; and a control system for controlling actuation of said electric motor/pump assembly so as to variable regulate the flow characteristics of said lubricant supplied from said sump to said lubrication channel.

Further areas of applicability of the present disclosure will become apparent from the detailed description provided hereinafter. It will be understood that the detailed description and specific example embodiments provided herein, while indicating particular configurations and functional characteristics, are intended for purposes of illustration only and are not intended to limit the scope of the inventive concepts associated with the present disclosure.

### BRIEF DESCRIPTION OF THE DRAWINGS

The drawings described herein are for illustrative purposes only of selected embodiments and not all possible implementations, and are not intended to limit the scope of the present disclosure.

The present disclosure will become more fully understood from the following detailed description and the accompanying drawings, wherein:

FIG. 1 is a schematic representation of a motor vehicle equipped with a power transfer system having a torque transfer mechanism and on-demand lubrication system in accordance with the teachings of the present disclosure;

FIG. 2 is a schematic illustration of the torque transfer mechanism shown in FIG. 1 configured as a single-speed transfer case;

FIG. 3 is a sectional view of an exemplary transfer case to which the on-demand lubrication system of the present disclosure can be readily adapted;

FIG. 4 is a perspective view of a front housing section of a transfer case and showing an electric fluid pump associated with the on-demand lubrication system mounted to an external surface of the housing section;

FIG. 5 is another perspective view of the front housing section of the transfer case and showing a supply tube fluidically interconnecting the electric fluid pump to a shaft reservoir assembly as part of the on-demand lubrication system of the present disclosure;

FIGS. 6 and 7 are additional perspective views, generally similar in orientation to FIG. 5, but showing various components mounted on the mainshaft of the transfer case.

FIG. 8 is an exploded perspective view of the electric fluid pump;

FIG. 9 is a sectional view of the electric fluid pump mounted to the housing section of the transfer case;

FIGS. 10A and 10B illustrate front and back views of the reservoir shaft assembly and supply tube associated with the on-demand lubrication system;

FIG. 11 illustrates the reservoir shaft assembly with its cover plate removed to illustrate the reservoir chamber defined with the reservoir housing;

FIG. 12 is a sectional view taken through the reservoir shaft assembly;

FIG. 13 is a pictorial view of an internal sump portion of the front housing section;

FIG. 14 is a partial sectional view taken through a portion of FIG. 13; and

FIG. 15 is a sectional view of a mainshaft of a transfer case showing a reservoir chamber of the shaft reservoir assembly in fluid communication with a flow passageway in the mainshaft.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The present disclosure is generally directed to a torque transfer mechanism for use in vehicular driveline application to transfer drive torque and/or limit slip between a pair of rotary components. More particularly, the torque transfer mechanism of the present disclosure includes an on-demand lubrication system. The torque transfer mechanism finds particular application in power transfer systems and may include, without limitation, transfer cases, power take-off units, drive axle modules, torque couplings and limited slip/torque-vectoring differential assemblies. Thus, while the present disclosure is directed to describing a particular configuration of one such torque transfer mechanism for use in a specific driveline application, it will be understood that the arrangement shown is intended to only illustrate examples of embodiments of the present disclosure.

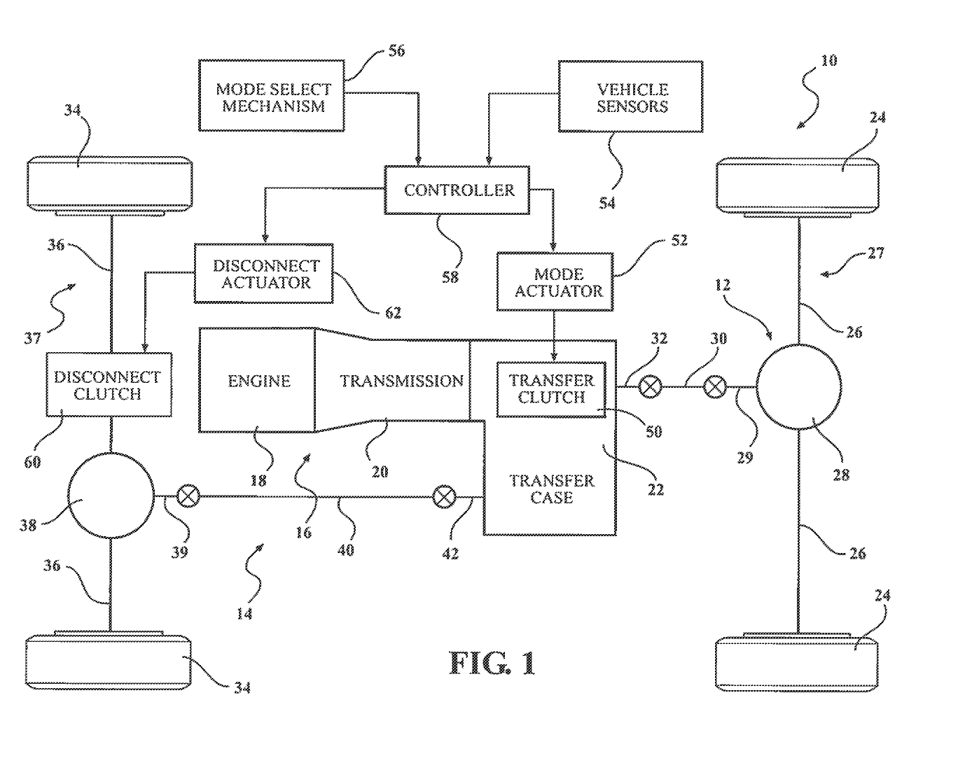

With particular reference to FIG. 1 of the drawings, a drivetrain 10 for a four-wheel drive motor vehicle is shown to include a first or primary driveline assembly 12, a second or secondary driveline assembly 14, and a powertrain assembly 16. Primary driveline assembly 12 is shown to define the rear driveline while secondary driveline assembly 14 defines the front driveline. Powertrain assembly 16 is operable to generate and deliver rotary power (i.e. drive torque) to the drivelines. Powertrain assembly 16 is shown to include an engine 18, a transmission 20 and a torque transfer mechanism hereinafter referred to as transfer case 22.

Primary driveline assembly 12 includes a pair of primary wheels 24 drivingly connected to a corresponding pair of primary axle shafts 26 associated with a primary axle assembly 27. Primary axle assembly 27 further includes a primary differential assembly 28 having a pair of output components drivingly connected to corresponding one of primary axle shafts 26 and which are driven through a speed-differentiating gearset by an input component. Primary differential assembly 28 can be of any known type capable of facilitating intra-axle speed differentiation between primary wheels 24.

Primary driveline assembly 12 further includes a primary propeller shaft or propshaft 30 having one end drivingly coupled to a pinion shaft 29 and another end drivingly coupled to a primary output shaft 32 of transfer case 22. Pinion shaft 29 is drivingly coupled via a final drive gearset to the input component of primary differential assembly 28.

Secondary driveline assembly 14 includes a pair of secondary wheels 34 drivingly connected to a corresponding pair of secondary axle shafts 36 associated with a secondary axle assembly 37. Secondary axle assembly 37 further includes a secondary differential assembly 38 having a pair of output components drivingly connected to corresponding one of secondary axle shaft 36 and which are driven through a speed-differentiating gearset by an input component. Secondary differential assembly 38 can include any type of gearset configured to facilitate intra-axle speed differentiation between secondary wheels 34. Secondary driveline assembly 14 further includes a secondary propeller or propshaft 40 having one end drivingly coupled to a pinion shaft 39 and another end drivingly coupled to a secondary output shaft 42 of transfer case 22. Pinion shaft 39 is drivingly coupled via a final drive gearset to the input component of secondary differential assembly 38.

With continued reference to FIG. 1, drivetrain 10 is shown to further include an electronically-controlled power transfer system for permitting a vehicle operator to select between a two-wheel drive mode (2WD), a locked four-wheel drive mode (L-4WD), and an adaptive or on-demand four-wheel drive mode (AUTO-4WD). In this regard, transfer case 22 is equipped with a transfer clutch 50 that can be selectively actuated for transferring drive torque from primary/rear output shaft 32 to secondary/front output shaft 42 to establish one of the locked and on-demand four-wheel drive modes. The power transfer system is shown to further include a mode actuator 52 for actuating transfer clutch 50, vehicle sensors 54 for detecting dynamic and operational characteristics of the motor vehicle and/or road/weather conditions, a mode select mechanism 56 for permitting the vehicle operator to select one of the available modes, and an electronic controller unit 58 for controlling actuation of mode actuator 52 in response to input signals from vehicle sensors 54 and mode select mechanism 55. A disconnect clutch 60 may be associated with one of secondary axle shafts 36 or, in the alternative, between pinion shaft 39 and differential assembly 38 to permit selective coupling and de-coupling of secondary wheels 34 relative to secondary propshaft 40. A disconnect actuator 62 is controlled by controller 58 for controlling actuation of disconnect clutch 60.

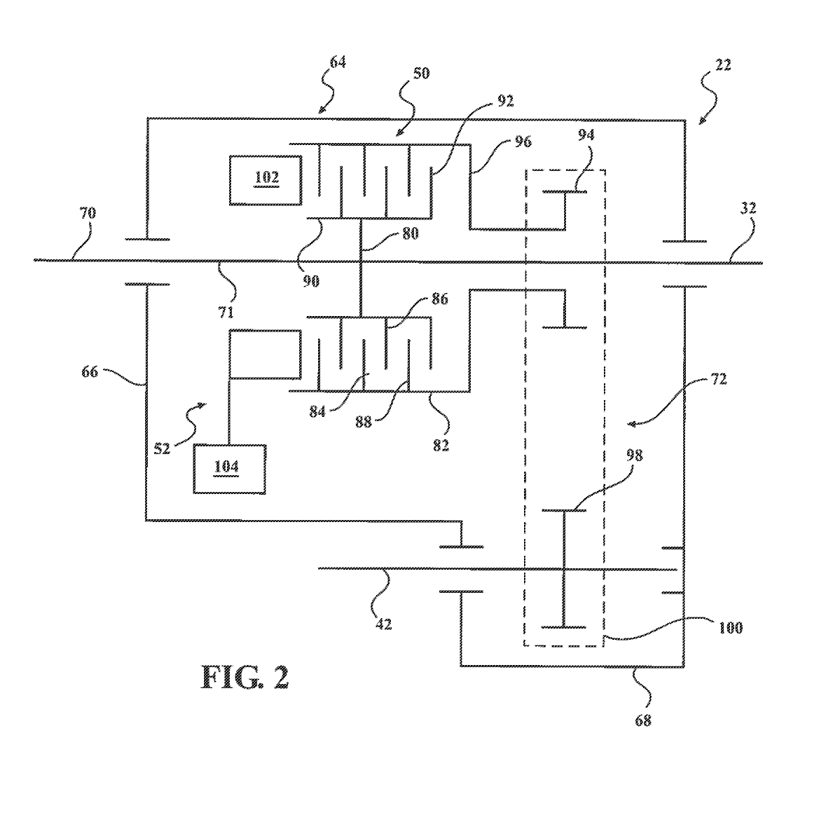

Referring now to FIG. 2, a schematic representation of an exemplary configuration for transfer case 22 is provided. Transfer case 22 is shown to include a two-piece housing assembly 64 having a first or front housing section 66 and a second or rear housing section 68. Transfer case 22 includes an input shaft 70, rear output shaft 32, front output shaft 42, transfer clutch 50, mode actuator 52, and a transfer assembly 72. Since transfer case 22 is a single-speed configuration, input shaft 70 and rear output shaft 32 are fixed for common rotation and may be formed integrally to define a mainshaft 71. Transfer clutch 50 is generally shown to include a clutch hub 80 fixed for rotation with mainshaft 71, a clutch drum 82, and a multi-plate clutch pack 84 including a plurality of alternatingly interleaved inner clutch plates 86 and outer clutch plates 88. Inner clutch plates 86 are splined to a cylindrical hub section 90 of clutch hub 80 while outer clutch plates 88 are splined to clutch drum 82. Clutch hub 80 is shown to include a reaction ring section 92 that is fixed to cylindrical hub section 90.

Transfer assembly 72 includes a first sprocket 94 fixed for rotation with a radial plate section 96 of clutch drum 82, a second sprocket 98, and a power chain 100 connecting first sprocket 94 for rotation with second sprocket 98. First sprocket 94 is rotatably supported on mainshaft 71 while second sprocket 98 is fixed for rotation with front output shaft 42.

Mode actuator 52 is schematically shown in FIG. 2 to include a clutch operator mechanism 102 and a power-operated drive unit 104. Drive unit 104 is adapted to receive control signals from controller 58 and cause clutch operator mechanism 102 to generate and exert a clutch engagement force on clutch pack 84. Precise regulation of the magnitude of the clutch engagement force controls the magnitude of drive torque transferred from mainshaft 71 through transfer clutch 50 and transfer assembly 72 to front output shaft 42.

When the 2WD mode is selected, clutch pack 84 is completely disengaged to disconnect front output shaft 42 from mainshaft 71, whereby all drive torque is transferred from powertrain assembly 16 to primary driveline 12. When the L-4WD mode is selected, clutch pack 84 is fully engaged to couple front output shaft 42 for rotation with mainshaft 71 and effectively split the total drive torque between primary driveline assembly 12 and secondary driveline assembly 14. When the AUTO-4WD mode is selected, the clutch engagement force applied to clutch pack 84 is adaptively varied to automatically vary the torque distribution between the driveline assemblies to provide optimized traction.

The schematic illustration of transfer case 22 in FIG. 2 is intended to broadly define a single-speed construction which can be assembled in any orientation of the components. In addition, it will be appreciated that transfer assembly 72 can be any type of chain-drive, belt-drive or gear-drive assembly capable of providing the desired function. Likewise, clutch operator mechanism 102 can be any known device capable of generating and applying a clutch engagement force on clutch pack 84 and may include, for example and without limitation, a ball ramp mechanism, a spindle drive mechanism, a pivot linkage mechanism, etc. Power-generated drive unit 104 may include any electromechanical, magnetorheological, electromagnetic or hydraulic device such as, for example and without limitation, an electric motor, a linear actuator, a solenoid actuator, an electromagnetic actuator and a hydraulic actuator. Transfer case 22 can further include a two-speed range shift system, an inter-axle differential and/or a mechanical mode lock system without departing from the inventive concepts disclosed herein.

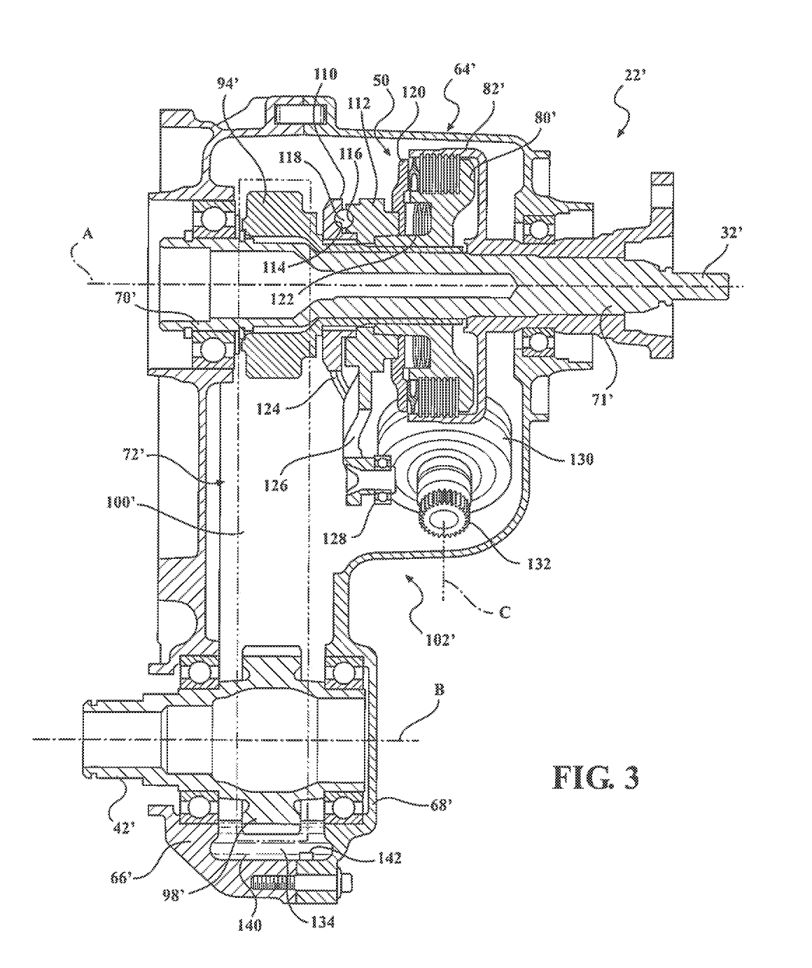

Referring to FIG. 3, an exemplary construction for a transfer case 22′ generally configured to be similar in function and structure to that of schematic transfer case 22 of FIG. 2 will now be described. Primed reference numerals are used to designate similar components. Specifically, clutch operator mechanism 102 is shown to include a bearing ring 110 and an adjusting ring 112 which are both rotatably supported with respect to rotary axis “A” of mainshaft 71′. Bearing ring 110 is axially supported while adjusting ring 112 is axially moveable. A plurality of ball ramps 114 are formed in bearing ring 110 while a common plurality of ball ramps 116 are formed in adjusting ring 112. These ball ramps 114, 116 extend in the circumferential direction with respect to rotary axis A and are inclined in a ramp-like manner—that is to say that ball ramps 114, 116 have a depth that varies in the circumferentially direction. A follower, such as a ball 118, is retained between each aligned pair of ball ramps 114, 116. By rotating at least one of bearing ring 110 and adjusting ring 112 relative to the other, an axial translational displacement of adjusting ring 112 is generated. Adjusting ring 112 acts on a pressure ring 120 (through a thrust bearing) which, in turn, is configured to apply the clutch engagement force on clutch pack 84. Pressure ring 120 is preloaded in the disengagement direction by means of a biasing spring mechanism 122.

A first activating lever 124 is integrally formed on bearing ring 110 and a second activating lever 126 is integrally formed on adjusting ring 112, A first follower (not shown) is rotatably supported on a free end of first activating lever 124 while a second follower 128 is rotatably supported on a free end of second activating lever 126. Each follower rolls on a corresponding cam surface of a rotary mode cam 130. The cam surfaces are profiled to generate a scissor-like movement of actuating levers 124, 126 in response to rotation of mode cam 130.

A drive shaft 132 is coupled to mode earn 130. Power-operated drive unit 104 would include an electric motor arranged to control rotation of driveshaft 132 and, in turn, mode earn 130. A sump chamber 134 filled with a lubricating fluid 140 is shown formed in housing 64 in proximity to front output shaft 42′. A temperature sensor 142 is located in sump chamber 134 and provides a signal T representing the temperature of lubricating fluid 140, the temperature signal being provided to controller 58.

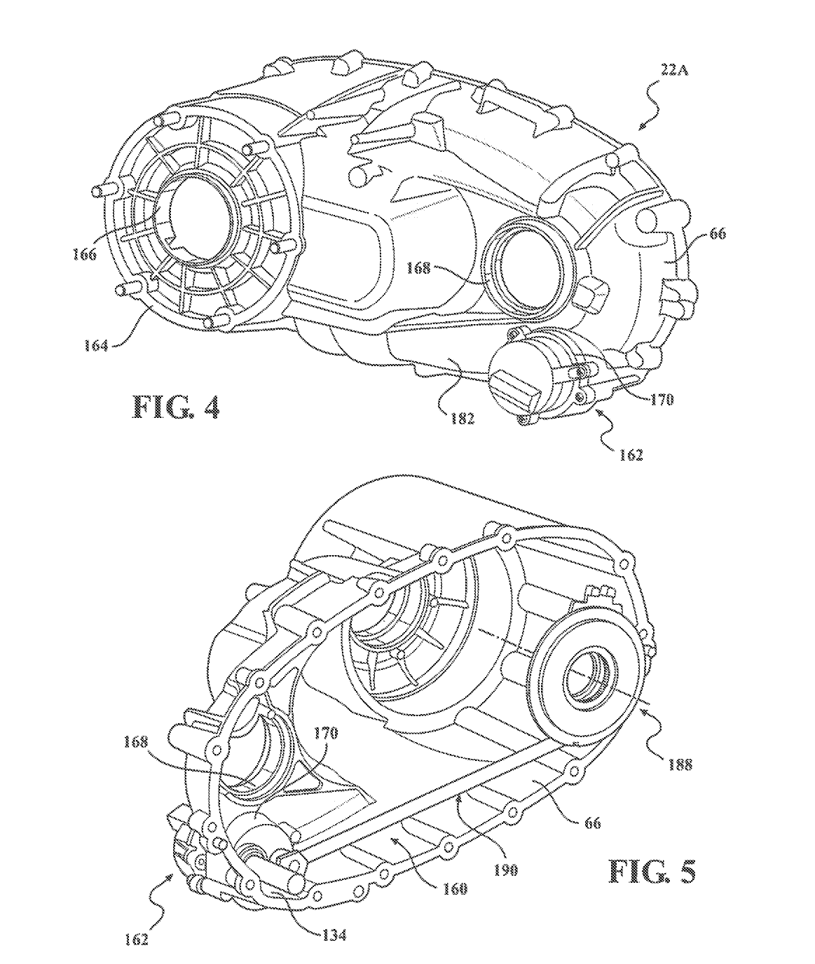

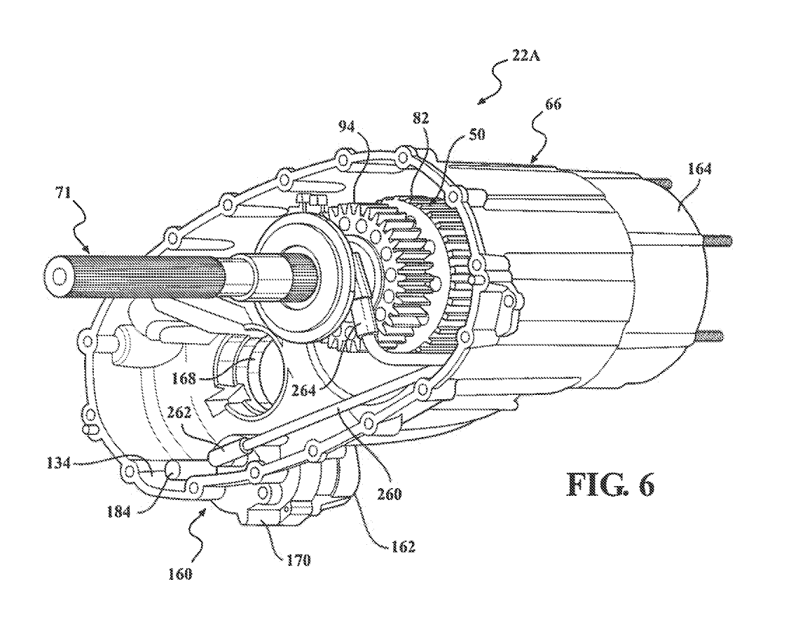

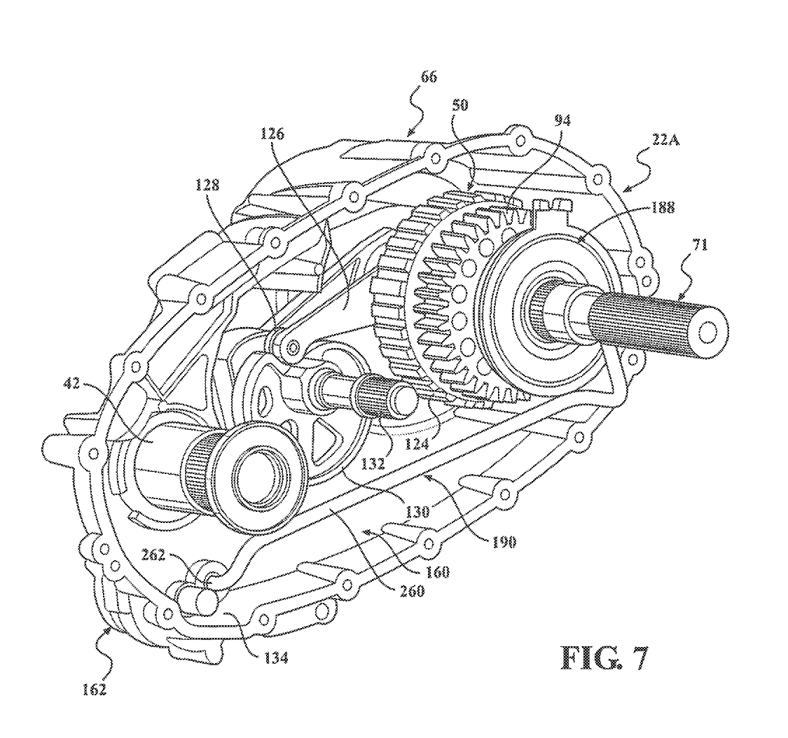

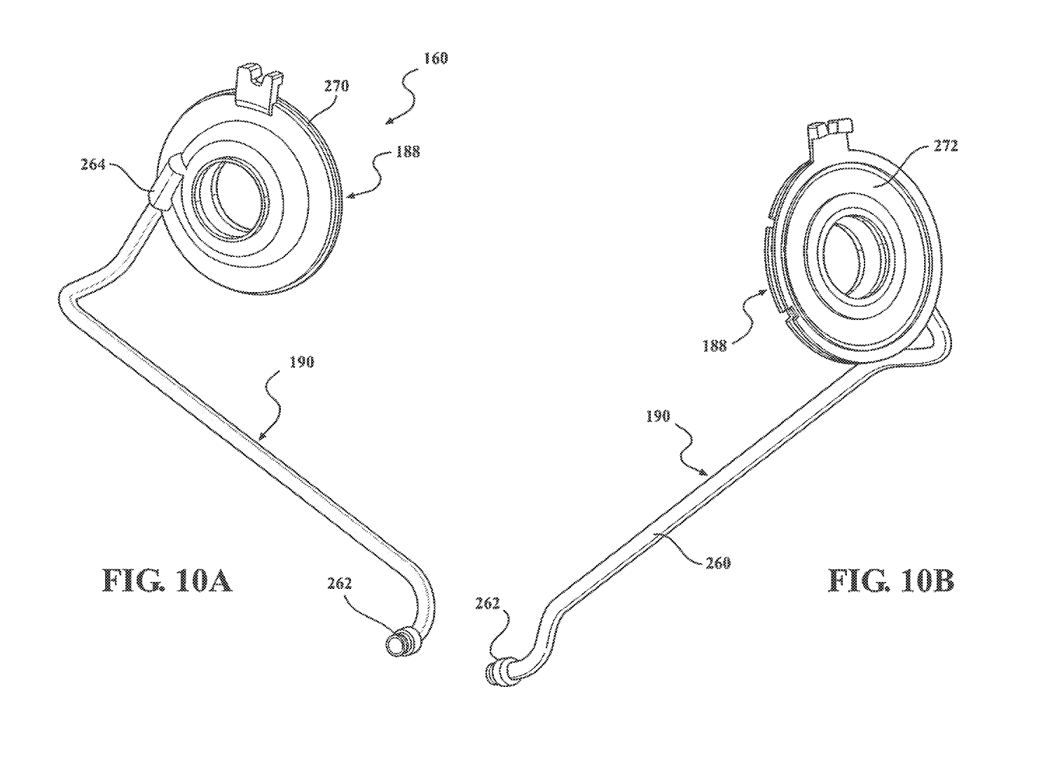

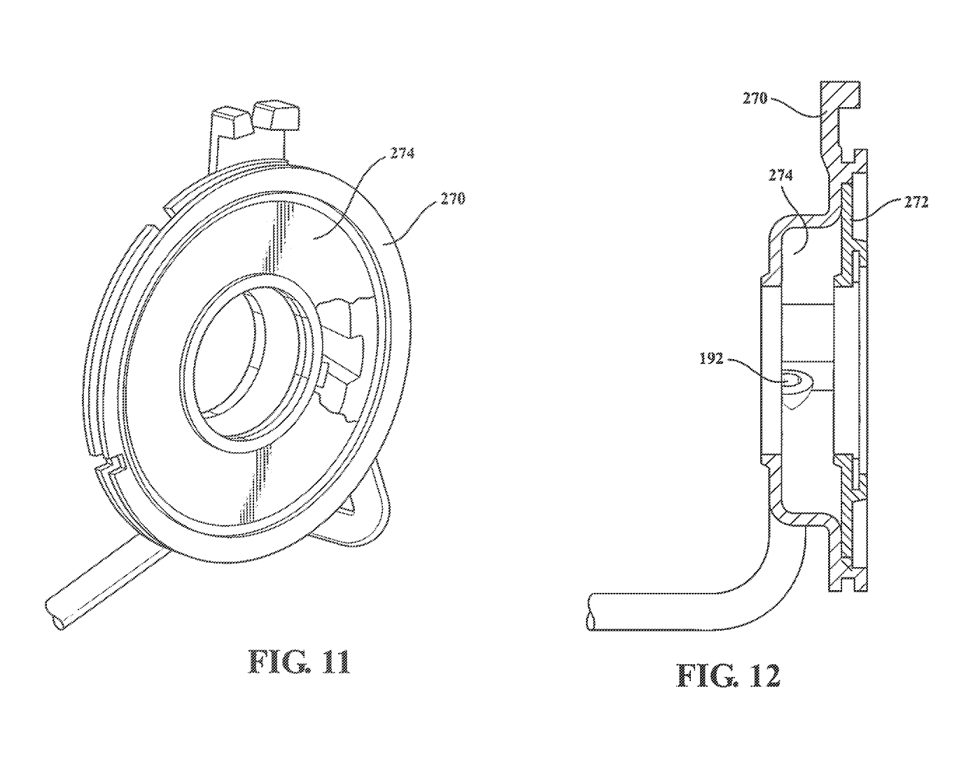

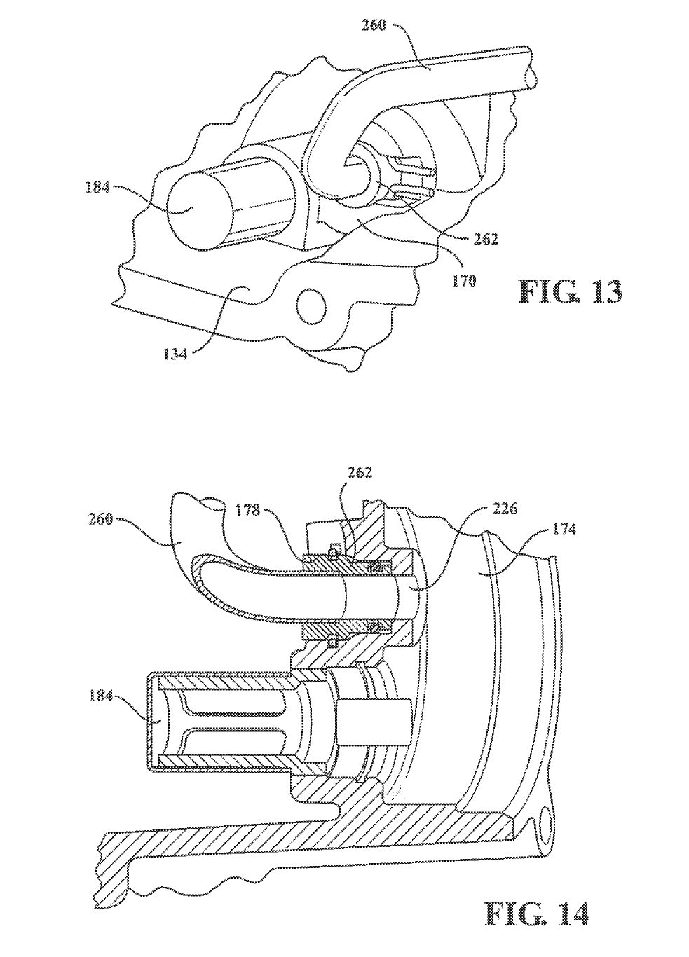

The present disclosure is generally directed to incorporation of an on-demand lubrication system 160 into transfer case 22 which includes an externally-mounted pump assembly 162. To this end, particular attention is now directed to FIGS. 4 through 15 for illustration and description of a transfer case 22A equipped with on-demand lubricator lubrication system 160. Those skilled in the art will appreciate the functional and structural similarity of transfer case 22A relative to transfer cases 22, 22′ such that common reference numerals are again used to identify similar components.

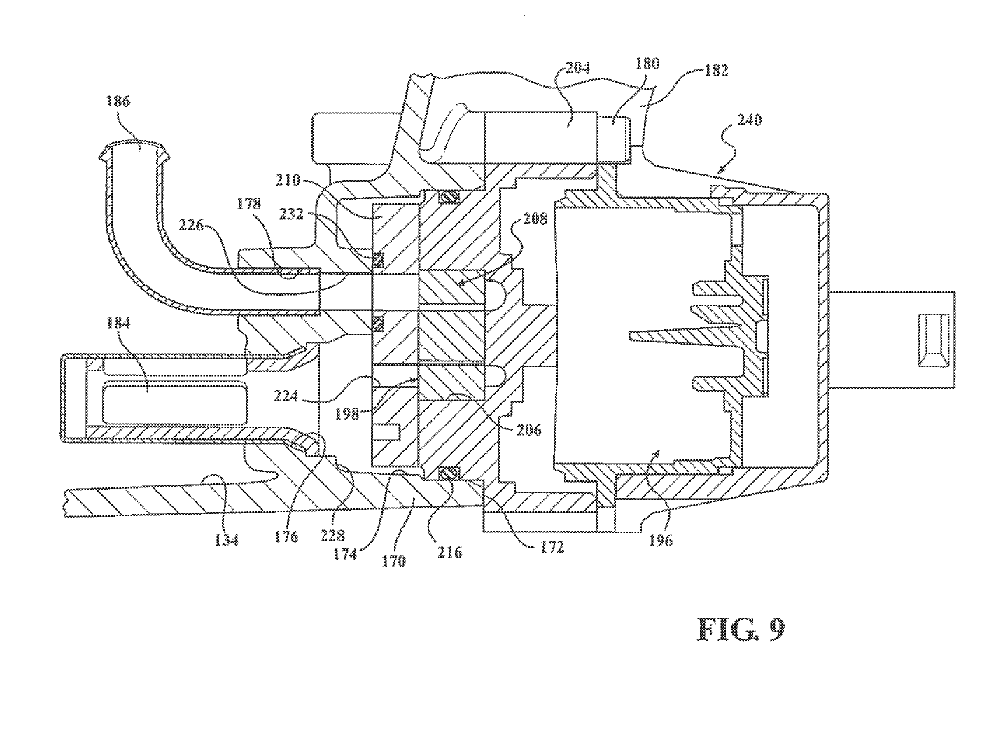

Referring to FIGS. 4 through 7, front housing section 66 of housing assembly 64 is shown to include a mounting flange 164 adapted for mounting transfer case 22A to transmission 20 and having an input aperture 166 through which a transmission output shaft (not shown) extends for driving connection to input shaft 70. Front housing section 66 also defines a front output aperture 168 through which front output shaft 42 extends for driving connection to propshaft 40. Front housing section 66 also defines a mounting boss 170 to which pump assembly 162 is mounted. As best shown in FIG. 9, mounting boss 170 defines a mounting flange 172, a pump mount cavity 174, a fluid inlet port 176, and a fluid outlet port 178. Fasteners, such as bolts 180, are used for securing fluid pump assembly 162 to mounting flange 172 on mounting boss 170, thereby orienting fluid pump assembly 162 adjacent an exterior surface 182 of front housing section 66. Inlet port 176 is located in a sump chamber 134 of housing assembly 64 and a filter unit 184 is mounted in inlet port 176.

In addition to fluid pump assembly 162, on-demand lubrication system 160 includes an output tube 186 mounted in outlet port 178, a shaft reservoir assembly 188 non-rotatably mounted to surround a portion of mainshaft 71, and a supply conduit assembly 190 fluidically interconnecting output tube 186 to an inlet aperture 192 of shaft reservoir assembly 188.

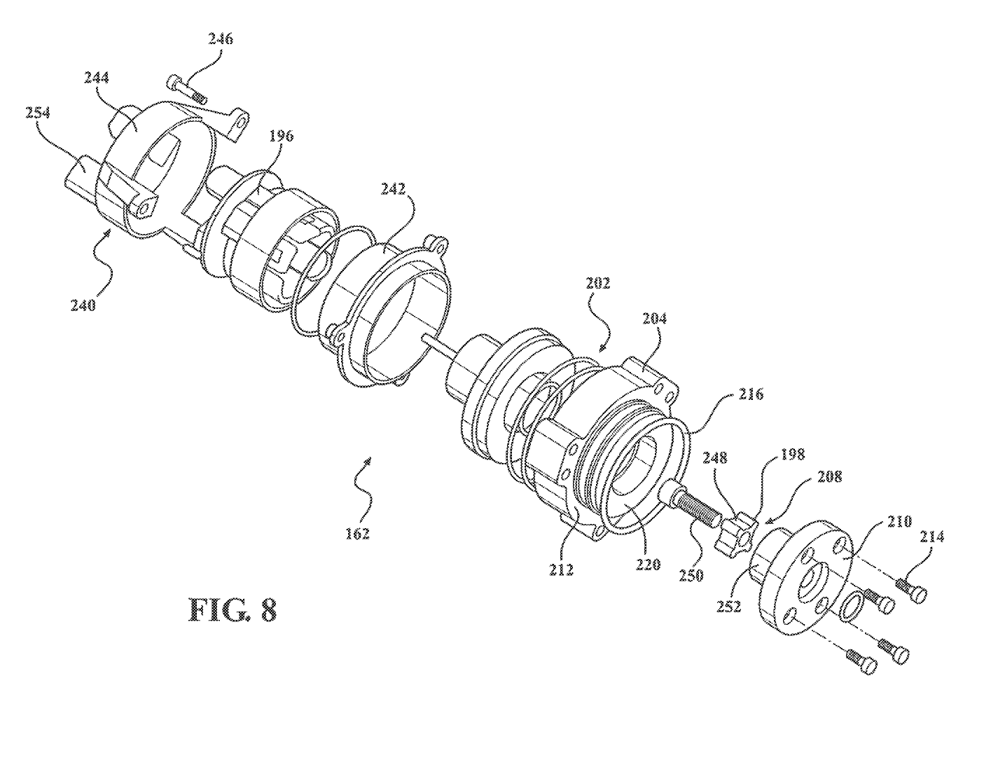

As best seen from FIGS. 8 and 9, fluid pump assembly 162 generally includes an electric motor 196, a gerotor pump 198 driven by electric motor 196, a control or circuit board 200, and a multi-piece pump housing assembly 202. Gerotor pump 198 includes a pump housing 204 that is configured for connection to mounting boss 170. Pump housing 204 defines an eccentric pump chamber 206, a gerotor gearset 208 disposed in pump chamber 206, and a pump plate 210 disposed in pump mount cavity 174 of mounting boss 170 and enclosing gerotor gearset 208 within pump chamber 206. Pump plate 210 is secured to a planar face surface 212 of pump housing 204 via a plurality of threaded fasteners 214. An O-ring seal 216 is retained in a groove 218 formed in a tubular portion 220 of pump housing 204 and is sealingly engaged with an inner diameter wall surface 222 of cavity 174. Pump plate 210 defines an inlet aperture 224 and an outlet aperture 226. Inlet aperture 224 is in fluid communication with a low pressure chamber portion 228 of cavity 174 which, in turn, is in fluid communication with fluid 140 in sump 134 via filter unit 184 and inlet port 176. A raised boss portion 230 in cavity 174 is formed to include outlet port 176 therethrough. Outlet aperture 226 of pump plate 210 is aligned with outlet port 178 and is sealed via an O-ring seal 232 relative to low pressure chamber portion 228 of cavity 174.

Electric motor 196 and controller 200 are disposed within a casing assembly 240 including a motor housing 242 and a cover plate 244 that are connected together and to pump housing 204 via threaded fasteners 246. A plurality of aligned lugs formed on each of motor housing 242, cover plate 244 and pump housing 204 are arranged to receive threaded fasteners 246. Electric motor 196 includes a rotor configured to drive an externally-lobed pump member 248 via a drive shaft 250. Externally-lobed pump member 248 is nested within an internally-lobed eccentric member 252, both of which together define gerotor gearset 208. A connector 254 formed on cover plate 244 provides an electrical connection between controller 58 and circuit board 200 for controlling actuation of electric motor 196 when it is desired to actuate gerotor pump 198. Actuation of gerotor pump 198 results in low pressure fluid within sump 134 being drawn through filter unit 184, inlet port 176 and into low pressure chamber 228 for delivery to inlet aperture 224. Rotation of gerotor gearset 208 causes the low pressure fluid to be pressurized and discharged from outlet aperture 226 into output tube 186 for delivery to a conduit 260 associated with supply conduit assembly 190. Supply conduit assembly 190 further includes a first coupling 262 for coupling a first end of conduit 260 to output tube 186, and a second coupling 264 for coupling a second end of conduit 260 to inlet aperture 192 of shaft reservoir assembly 188.

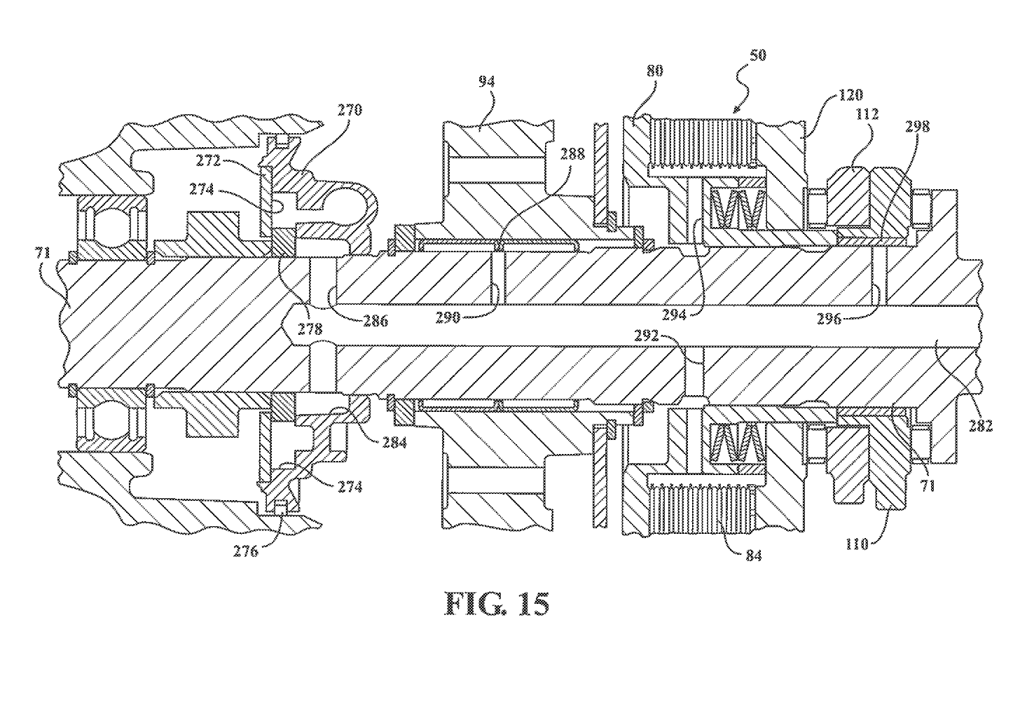

Shaft reservoir assembly 188 is shown to include a reservoir housing 270 and a back plate 272 which together define an annular supply chamber 274. A retaining ring 276 is provided to axially fix reservoir assembly 188 relative to housing section 66. A seal 278 cooperates with back plate 272 and housing 270 to seal supply chamber 274 relative to an outer surface 280 of mainshaft 71. Supply chamber 274 is in fluid communication with inlet aperture 192 formed in reservoir housing 270. FIG. 15 illustrates a central lubrication bore 282 formed to extend along rotary axis A. Central bore 282 is in fluid communication with an annular outlet channel 284 formed in reservoir housing 270 via a plurality of radial inlet ports 286 formed/machined into mainshaft 71. Annular outlet channel 284 is in fluid communication with annular supply chamber 274. As such, pressurized lubricating fluid 140 generated by pump assembly 162 is supplied through conduit 260, annular supply chamber 274 and outlet charmer 284 to central lubrication bore 282 via radial net ports 286. Lubricating fluid supplied to central lubrication bore 282 is fed to sprocket bearings 288 (supporting first sprocket 94) via a set of first radial outlet ports 290 formed/machined into mainshaft 71. As is also shown, lubricating fluid discharged from a plurality of second radial outlet ports 292 is supplied to clutch pack 84 via radial lube ports 294 formed in clutch hub 80. Finally, a plurality of third radial outlet ports 296 supply pressurized lubricating fluid from central lubrication bore 292 to lubricate actuator bearings 298 shown to be rotatably supporting bearing ring 110.

The on-demand lubrication system disclosed above is advantageous since it allows service repair or replacement of fluid pump assembly 162 easily without the need to disassemble housing assembly 64 of transfer case 22. This arrangement is also well suit for use as an optional installation to a conventional shaft-driven gerotor pump type of lubrication system. Specifically, shaft reservoir assembly 188 can be configured to replace the gerotor pump assembly conventionally mounted on mainshaft 71 and supply pressurized fluid on-demand to the pre-existing central bore formed/machined in the mainshaft. Thus, existing shafts, hubs, actuators, bearings and the like can be lubricated in otherwise conventional transfer case retrofitted or initially installed with on-demand lubrication system 160. Unlike conventional mechanical (i.e. shaft-drive) pumps, electric motor/pump assembly 162 can be controlled so that oil flow characteristics can be regulated and optimized for instantaneous cooling and lubrication requirements while minimizing drag losses. Specifically, pump assembly 162 can be automatically controlled to provide lubricant flow at very low vehicle speeds and/or in reverse gear and also driving 4WD operation to optimize lubrication and thermal management of bearings and clutch components. Actual optimized control of the lubricant flows characteristics can be based on any number of vehicle operational inputs and/or road and environmental conditions including, but not limited to, vehicle speed, lubricant temperature, 2WD/4WD mode status, ambient temperature and the like.

Those skilled in the art will recognize the advantages associated with providing a power transfer system with a torque transfer mechanism having an on-demand lubrication system of the present disclosure. As such, the present teachings are expressly intended to encompass the inclusion of an externally-mounted fluid pump assembly in conjunction with internal lubricant supply and delivery components in torque transfer mechanisms other than transfer cases. These alternative torque transfer mechanisms may include, without limitation, power take-off units, torque couplings, axle drive modules, limited slip differentials and torque vectoring assemblies having a friction clutch and rotary components that can be lubricated/coded with greater efficiency and optimization by integration of the on-demand lubrication system of the present inventions.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and having,” are inclusive and therefore specify the presence of stated features, integers, steps, operations, elements, and/or components, but do not preclude the presence or addition or one or more other features, integers, steps, operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged,” “directly connected,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing form the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and ail such modifications are intended to be included within the scope of the disclosure.

What is claimed is:

1. A torque transfer mechanism for use in a motor vehicle to transfer torque from a first rotary member to a second rotary member, comprising:
a housing defining an enclosed chamber and configured to rotatably support each of the first and second rotary members;
a supply of liquid lubricant disposed within a sump portion of said enclosed chamber;
an on-demand lubrication system including an electric motor/pump assembly, a reservoir assembly, and a conduit assembly, said electric motor/pump assembly being mounted to an external surface of said housing and disposed in a cavity defining an inlet port and an outlet port which both communicate with said enclosed chamber, said electric motor/pump assembly operable to draw lubricant from said sump portion into said inlet port and discharge pressurized lubricant from said outlet port, said conduit assembly providing a fluid pathway from said outlet port to an inlet aperture in said reservoir assembly, said reservoir assembly surrounding one of the first and second rotary members and defining an annular channel providing fluid communication between said inlet aperture and a control lubrication channel formed in the one of the first and second rotary members; and
a control system for controlling actuation of said electric motor/pump assembly so as to variable regulate the flow characteristics of said lubricant supplied from said sump to said lubrication channel.

2. The torque transfer mechanism as set forth in claim 1 wherein said housing includes a mounting boss defining said cavity, and wherein said electric motor/pump assembly extends into said cavity and is connected to said mounting boss.

3. The torque transfer mechanism as set forth in claim 2 wherein electric motor/pump assembly includes a gerotor pump for drawing said lubricant from said sump portion into said inlet port and discharging pressurized lubricant from said outlet port, and an electric motor operably connected to said gerotor pump for driving said gerotor pump.

4. The torque transfer mechanism as set forth in claim 3 wherein said gerotor pump includes a pump housing connected to said mounting boss and defining an eccentric pump chamber, and a gerotor gearset disposed in said eccentric pump chamber, and wherein said gerotor gearset includes an internally lobed eccentric member and an externally lobed pump member nested within said internally lobed eccentric member, and wherein said externally lobed pump member is operably connected to said electric motor for being rotated by said electric motor for drawing said lubricant from said sump portion through said inlet port and for pressurizing and discharging said lubricant through said outlet port.

5. The torque transfer mechanism as set forth in claim 4 and further including a pump plate disposed in said cavity of said mounting boss and connected to said pump housing and enclosing said gerotor gearset within said pump chamber.

6. The torque transfer mechanism as set forth in claim 5 wherein said pump plate defines an inlet aperture aligned with said inlet port and an outlet aperture aligned with said outlet port for allowing said lubricant to pass through said pump plate and to said gerotor gearset.

7. The torque transfer mechanism as set forth in claim 4 wherein a seal is disposed between said pump housing and said mounting boss in said cavity of said mounting boss for sealing said pump housing and said mounting boss.

8. The torque transfer mechanism as set forth in claim 4 and further including a casing assembly including a motor housing and a cover plate, and wherein said motor housing is connected to said pump housing and said cover plate is connected to said motor housing to close said motor housing, and wherein said electric motor is disposed in said casing assembly.

9. The torque transfer mechanism as set forth in claim 8 wherein said control system includes a controller disposed in said casing assembly.

10. The torque transfer mechanism as set forth in claim 8 wherein said motor housing, said cover plate, and said pump housing define a plurality of sets of lugs being in coaxial alignment with one another, and wherein a plurality of threaded fasteners each extend through one of said sets of lugs for securing said motor housing, said cover plate, and said pump housing to one another.

11. The torque transfer mechanism as set forth in claim 1 wherein said reservoir assembly includes a reservoir housing disposed about said first rotary member and a back plate connected to said reservoir housing and disposed about said first rotary member to define an annular supply chamber between said reservoir housing and said back plate, and said reservoir housing defines said inlet aperture extending into said annular supply chamber for receiving said pressurized lubricant from said conduit assembly.

12. The torque transfer assembly as set forth in claim 11 wherein a seal is disposed between said back plate, said reservoir housing, and said first rotary member to seal said supply chamber relative to said first rotary member.

13. The torque transfer assembly as set forth in claim 11 wherein a retaining ring is fixedly disposed radially between said reservoir assembly and said housing for axially fixing said reservoir assembly to said housing.

14. The torque transfer assembly as set forth in claim 1 wherein a filter unit is disposed in said inlet port for filtering said lubricant being passed through said inlet port.

15. The torque transfer assembly as set forth in claim 1 and further including an outlet tube extending between said outlet port and said conduit assembly for conveying said lubricant between said outlet port and said conduit assembly.

16. The torque transfer assembly as set forth in claim 1 and further including a transfer clutch for connecting to the first rotary member for transmitting torque from said first rotary member, and wherein said reservoir assembly further defines at least one second radial outlet port extending between said control lubrication channel and said transfer clutch for providing said lubricant to said transfer clutch.

17. The torque transfer mechanism as set forth in claim 16 wherein said transfer clutch includes a clutch hub being fixed for rotation with said inlet shaft, a clutch drum, and a multi-plated clutch pack including a plurality of alternating interleaved inner clutch plates and outer clutch plates, and wherein said inner clutch plates are splined to said clutch hub and said outer clutch plates are splined to said clutch drum, and wherein said second radial outlet port extends to said clutch pack for providing said lubricant to said clutch pack.

18. The torque transfer mechanism as set forth in claim 16 and further including a transfer assembly interconnecting said transfer clutch and said second rotary member, and wherein said reservoir assembly further defines at least one first radial cutlet port that extends between said control lubrication channel and said transfer clutch for providing said lubricant to said transfer assembly.

19. The torque transfer mechanism as set forth in claim 18 wherein said transfer assembly further includes a first sprocket fixed for rotation with said clutch drum, a second sprocket for being fixed for rotation with the second rotary member, a power chain connecting said first sprocket and said second sprocket for providing rotation of said second sprocket in response to rotation of said first sprocket, and at least one sprocket bearing for supporting said first sprocket about said first rotary member, and wherein said first radial outlet port extends to said sprocket bearing for providing said lubricant to said sprocket bearing.

20. The torque transfer mechanism as set forth in claim 16 and further including a clutch operator mechanism for generating and applying a clutch engagement force on said transfer clutch, and wherein said reservoir assembly further defines at least one third radial outlet port that extends between said control lubrication channel and said clutch operator mechanism for providing said lubricant to said clutch operator mechanism.
